(19) United States
(12) Patent Application Publication
(10) Pub. No.: US 2007/0046861 A1
(43) Pub. Date: Mar. 1, 2007

(54) Liquid crystal display apparatus

(75) Inventor: Masato Morita, Kanagawa (JP)

Correspondence Address: SUGHRUE-265550, 2100 PENNSYLVANIA AVE. NW, WASHINGTON, DC, 20037-3213, US

(73) Assignee: FUJI PHOTO FILM CO., LTD.

(21) Appl. No.: 11/511,281

(22) Filed: Aug. 29, 2006

(30) Foreign Application Priority Data
Aug. 29, 2005 (JP) P2005-247910
Aug. 29, 2005 (JP) P2005-247913

(51) Int. Cl. G02F 1/1335

(52) U.S. Cl. 349/95

(57) ABSTRACT

A liquid crystal display apparatus includes: an image display member diffracting an incident light; a focusing member condensing diffracted lights diffracted by the image display member; and a optical element recombining lights condensed by the focusing member, wherein the image display member comprises a liquid display panel having a pixel arrangement, and the optical element has a pixel arrangement being a point symmetrical to the pixel arrangement of the image display member.

### BACKGROUND OF THE INVENTION

1. Field of the Invention

The present invention relates to a liquid crystal display apparatus for use in a liquid crystal projector and the like, and particularly to a liquid crystal display apparatus capable of preventing a loss in a contrast ratio and of realizing a high-speed operation.

2. Background Art

A liquid crystal panel employed in a liquid crystal projector generally has a pixel size, much smaller than that in an ordinary personal computer or a television monitor. Therefore, such liquid crystal panel involves a phenomenon that a projecting light shows a large diffraction angle when it is diffracted at an edge portion between a light transmitting part and a light non-transmitting part of the pixels, with a large amount of diffracted light.

A contrast ratio (CR) of a displayed image is defined by a ratio of luminances of a white display state and a black display state. A white display state is scarcely influenced by a diffraction of light at an edge portion between a light transmitting part and a light non-transmitting part of the pixels. On the other hand, in a black display state, the light is diffracted, between a polarizing plate in front and a polarizing plate at rear in the proceeding direction of the light, at an edge portion between a light transmitting part and a light non-transmitting part of the pixels. As a result, the light shows changes in a proceeding direction and in a polarizing direction thereof between the two polarizing plates to result in a light leakage, thus increasing the luminance. This phenomenon leads to a defect of a reduced CR of the displayed image.

Also the liquid crystal panel, in which a transmitted light amount is regulated by controlling the alignment direction of the liquid crystal molecules by a voltage, has a slower operation speed in comparison with other displays such as a CRT because of a slow aligning speed of the liquid crystal molecules, and is generally inferior in the ability of displaying a moving image.

### SUMMARY OF THE INVENTION

The present invention, that has been made in consideration of the aforementioned situation, is to provide a liquid crystal display apparatus capable of resolving the optical diffraction thereby avoiding a loss in the contrast ratio, and also of a high-speed operation.

(1) A liquid crystal display apparatus comprising: an image display member diffracting an incident light; a focusing member condensing diffracted lights diffracted by the image display member; and a optical element recombining lights condensed by the focusing member, wherein the image display member comprises a liquid display panel having a pixel arrangement, and the optical element has a pixel arrangement being a point symmetrical to the pixel arrangement of the image display member.

(2) The liquid crystal display apparatus as described in the item (1), wherein the focusing member is one of a lens and a mirror.

(3) The liquid crystal display apparatus as described in the item (1) or (2), wherein the optical element comprises a pixel-structured filter including a translucent substrate and a pixel layer corresponding to the image display member.

(4) The liquid crystal display apparatus as described in any one of the items (1) to (3), which comprises: polarizing elements are provided at a light entrance side and a light exit side of the image display member, respectively.

(5) The liquid crystal display apparatus as described in any one of the items (1) to (4), wherein the image display member comprises: a translucent panel substrate; a liquid crystal layer formed on the panel substrate; and a pixel layer.

(6) The liquid crystal display apparatus as described in any one of the items (1) to (5), wherein the focusing member comprises a pair of lenses, and the diffracted lights are changed to parallel lights by one lens and the parallel lights are condensed to the optical element by the other.

(7) A liquid crystal display apparatus comprising: a first image display member diffracting an incident light; a focusing member for condensing diffracted lights diffracted by the first image display member; and a optical element for recombining lights condensed by the focusing member, wherein each of the first image display member and the optical element are liquid display panels having a pixel arrangement, and the optical element has a pixel arrangement which is point symmetrical to the pixel arrangement of the first image display member.

(8) The liquid crystal display apparatus as described in the item (7), wherein the focusing member is one of a lens and a mirror.

(9) The liquid crystal display apparatus as described in the item (7) or (8), which comprises, polarizing elements are provided at a light entrance side of the first image display member and at a light exit side of the optical element, respectively.

(10) The liquid crystal display apparatus as described in any one of the items (7) to (9), wherein the image display member comprises: a translucent panel substrate; a liquid crystal layer formed on the panel substrate; and a pixel layer.

(11) The liquid crystal display apparatus as described in any one of the items (7) to (10), wherein the optical element comprises: a translucent panel substrate; a liquid crystal layer formed on the panel substrate; and a pixel layer.

(12) The liquid crystal display apparatus as described in any one of the items (7) to (11), wherein the focusing member comprises a pair of lenses, and the diffracted lights are changed to parallel lights by one lens and the parallel lights are condensed to the optical element by the other.

The liquid crystal display apparatus of the invention has such a structure of diffracting a light by the first image display member and then recombining the light onto the second image display member, in which the second image display member is provided in a position optically conjugate with the pixel arrangement of the first image display member and is so constructed to have a pixel arrangement that is point symmetrical to the pixel arrangement of the first image display member. Thus the diffraction can be prevented by diffracting the incident light by the image display member, and again recombining the light by the focusing member onto an optical element. Therefore, as the proceeding direction and the polarizing direction do not change between the incident light and the emergent light, it is possible to prevent an increase in the luminance by a light leakage. Thus a loss in the contrast ratio of the displayed image can be prevented.

It is also possible, by constituting each of the first image display member and the second image display member by a liquid crystal panel, to halve the burden per a liquid crystal panel, thereby increasing the operation speed. In a simple calculation, an operation of a doubled operation speed is possible. Since a phase difference given to the incident light can be halved per a liquid crystal panel, an alignment control amount for the liquid crystal molecules is accordingly reduced to about a half, whereby a high-speed operation is made possible.

Thus the present invention allows to provide a liquid crystal display apparatus capable of avoiding the diffraction of light and preventing the loss in the contrast ratio, and enabling a high-speed operation.

### BRIEF DESCRIPTION OF THE DRAWINGS

The invention disclosed herein will be understood better with reference to the following drawings of which:

FIGS. 1A to 1C are views that illustrate a liquid crystal display apparatus of a first embodiment of the invention, and FIG. 1A is a schematic view that illustrates a liquid crystal display apparatus of a first embodiment of the invention; FIG. 1B is a view that illustrates a pixel arrangement structure of an image display member; and FIG. 1C is a view that illustrates a pixel arrangement structure of a polarizing plate;

FIG. 2 is a view that illustrates a structure of the image display member;

FIG. 3 is a view that illustrates a structure of the polarizing plate;

FIGS. 4A to 4C are views that illustrate a liquid crystal display apparatus of a second embodiment of the invention, FIG. 4A is a schematic view that illustrates a liquid crystal display apparatus of a second embodiment of the invention; FIG. 1B is a view that illustrates a pixel arrangement structure of a first image display member; and FIG. 1C is a view that illustrates a pixel arrangement structure of a optical element;

FIG. 5 is a view that illustrates a structure of the first image display member;

FIG. 6 is a view that illustrates a structures of the optical element; and

FIG. 7 is a chart that illustrates a relationship, in a moving image display, between a voltage (V) applied for controlling the alignment of the liquid crystal molecules, and a phase difference (retardation Re) given to the light.

### DETAILED DESCRIPTION OF THE INVENTION

In the following, a first embodiment of the present invention will be explained with reference to the accompanying drawings.

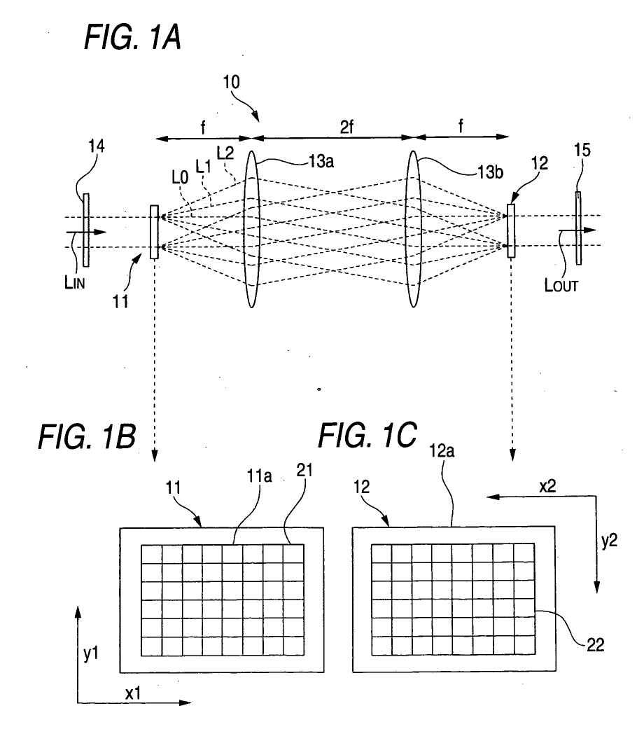

FIG. 1A is a view that illustrates a liquid crystal display apparatus of the invention; FIG. 1B is a view that illustrates a pixel arrangement structure of the image display member; and FIG. 1C is a view that illustrates a pixel arrangement structure of the optical element. FIG. 1B illustrates a plan view showing the image display member seen from the side of the focusing member, and FIG. 1C illustrates a plan view of the optical element seen from the side of the focusing member.

The liquid crystal display apparatus 10 of the present embodiment is adapted for use, for example, in a liquid crystal projector. As illustrated in FIG. 1A, the liquid crystal display apparatus 10 includes an image display member 11 for diffracting the incident light Lᵢₙ, a focusing member 13a and 13b for condensing the diffracted lights, diffracted by the image display member 11, and an optical element 12 for recombining the lights condensed by the focusing member 13a and 13b.

In the present embodiment, the focusing member 13a and 13b be made of a pair of lenses, and the diffracted lights are polarized to parallel lights by one lens 13a and the parallel lights are condensed to the optical element 12 by the other 13b. If a distance between the image display member 11 and one lens 13a is defined as “f”, a distance between lenses 13a and 13b is defined as “2f”. Whereby diffracted lights are properly polarized to parallel lights.

The liquid crystal display apparatus 10 may include a polarizing plate 14 serving as polarizing element at the light entrance side of the image display member 11. It may also include a polarizing plate 15 serving as polarizing element at the light exit side of the optical element 12.

In the present embodiment, a liquid crystal panel is used as the image display member 11. As illustrated in FIG. 1B, the image display member 11 includes a translucent panel substrate 11a, on which a pixel layer 21 is formed. The pixel layer 21 had a predetermined pixel arrangement.

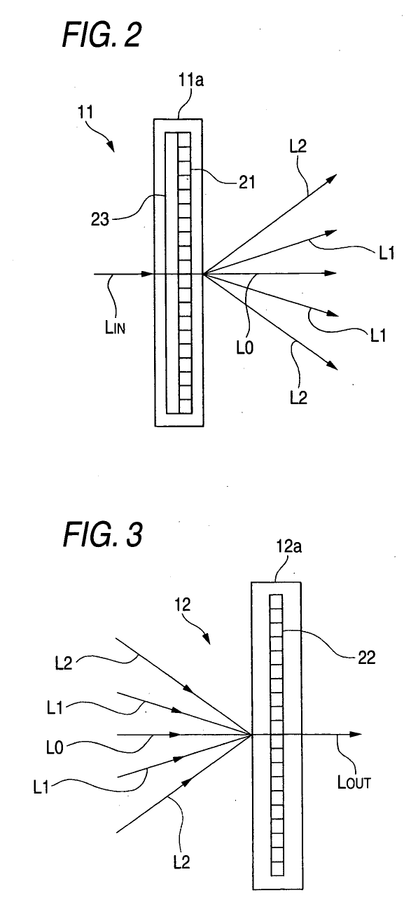

FIG. 2 illustrates a structure of the first image display member. As illustrated in FIG. 2, the image display member 11 is provided, on the panel substrate 11a, with a pixel layer 21 and a liquid crystal layer 23. In the illustrated example, the liquid crystal layer 23 is formed at the light entrance side of the pixel layer 21. Such structure allows to prevent a situation where the lights are not appropriately recombined in the optical element 12 due to a change in the phase of the light when the incident light Lᵢₙ is passed through the liquid crystal layer 23 after it is diffracted.

The focusing member 13a and 13b has a function of condensing, onto the optical element 12, diffracted lights (1st-order light L1 and 2nd-order light L2 in FIG. 1) of the incident light Lᵢₙ, diffracted from the light which proceeds straight (0th-order light L0 in FIG. 1) from the image display member 11. A lens or a mirror may be utilized as the focusing member 13a and 13b.

FIG. 3 illustrates the structure of the optical element. As illustrated in FIGS. 1C and 3, the optical element 12 has a function of recombining the diffracted lights (L1 and L2) condensed by the imaging member 13b. The light Lₒᵤₜ recombined by the optical element 12 is guided, in case of a liquid crystal projector, to a projection lens and projected onto a screen.

The optical element 12 may be constituted of a liquid crystal panel, having a same structure as in the image display member 11. The optical element 12 is characterized in having a pixel arrangement, that is point symmetrical to that of the image display member 11. More specifically, as illustrated in FIGS. 1B and 1C, coordinates of each pixel in the pixel arrangement, when the optical element 12 is seen as a plan view from the side of the focusing member 13a and 13b, correspond to those in pixel arrangement of the image display member 11, seen as a plan view from the side of the focusing member 13a and 13b, in a state rotated by 180° about a center of the pixel arrangement. Stated differently, a direction of x1 axis of the image display member 11 illustrated in FIG. 1B corresponds to a direction of x2 axis of the optical element 12 illustrated in FIG. 1C, and a direction of y1 axis of the image display member 11 illustrated in FIG. 1B corresponds to a direction of y2 axis of the optical element 12 illustrated in FIG. 1C.

In the present embodiment, a distance between the image display member 11 and the focusing member 13a, and a distance between the focusing member 13b and the optical element 12 are in such an optically conjugate relationship that the diffracted lights from the image display member 11 can be recombined by the optical element 12.

The liquid crystal display apparatus 10 of the invention is so constructed that the light is diffracted by the image display member 11 and is then recombined by the focusing member 13a and 13b onto the optical element 12, and that the optical element 12 is optically conjugate with the pixel arrangement of the image display member 11 and has a pixel arrangement which is point symmetrical with that of the image display member 11. The diffraction can be prevented by once diffracting the incident light by the image display member 11 and recombining the diffracted lights by the focusing member 13a and 13b onto the optical element 12. Therefore, the proceeding direction and the polarizing direction are not changed between the incident light Lᵢₙ and the emergent light Lₒᵤₜ, whereby a luminance increase by a light leak can be prevent. Therefore a loss in the contrast ratio of the displayed image can be prevented.

In the following, an example of the liquid crystal display apparatus of the first embodiment will be explained.

The liquid crystal display apparatus of the present example employed, as each of the first image display member and the optical element, a liquid crystal panel having a pixel pitch d of 25 μm, having, at a wavelength of λ=550 nm, a ±1st-order diffraction angle of ±1.26° and a diffraction angle to ±3rd order of ±3.78°. The focusing member was constituted, in consideration of a spreading (about ±10°) in the light incident angle to the liquid crystal panel, of a lens having a focal length of f=50 mm, capable of covering an angle within ±14° (preferably having a diameter of 50 mm of larger, and may be a Fresnel lens). The liquid crystal panel and the lens had a distance of 100 mm, and the lens and the optical element had a distance of 100 mm. The lights diffracted by the liquid crystal panel were condensed by the lens onto the optical element, and were thus recombined by a process inverse to the diffraction. A loss in the contrast ratio could be prevented by the present example.

The diffraction angle θ can be represented by θ=sin⁻¹(mλ/d), in which d sin θ=mλ, wherein m is a diffraction orde, d is a pitch of pixels and λ is a wavelength.

In the following, a second embodiment of the present invention will be explained with reference to the accompanying drawings. In addition, in the second embodiment as explained follow, the same number or reasonable number is assigned to a member having the same structure and function as explained already in the first embodiment so as to simplify and omit an explanation about the member.

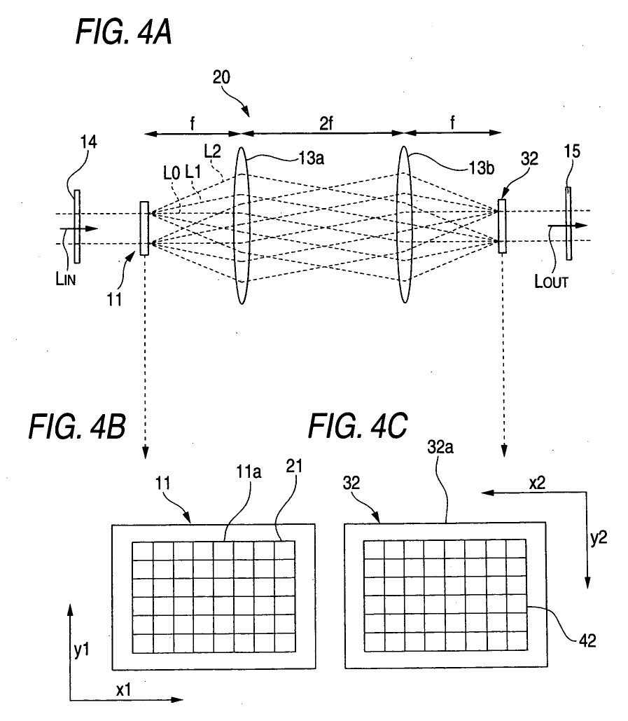

FIG. 4A is a view that illustrates a liquid crystal display apparatus of a second embodiment of the invention; FIG. 4B is a view that illustrates a pixel arrangement structure of the first image display member; and FIG. 4C is a view that illustrates a pixel arrangement structure of the second image display member. FIG. 4B illustrates a plan view of the first image display member seen from the side of the focusing member, and FIG. 4C illustrates a plan view of the second image display member seen from the side of the focusing member.

The liquid crystal display apparatus 20 of the present embodiment is adapted for use, for example, in a liquid crystal projector. As illustrated in FIG. 4A, the liquid crystal display apparatus 20 includes a first image display member 11 for diffracting the incident light Lᵢₙ, a focusing member 13a and 13b for condensing the diffracted lights, diffracted by the first image display member 11, and a second image display member 32 for recombining the lights condensed by the focusing member 13a and 13b.

The liquid crystal display apparatus 20 may include a polarizing plate 14 at the light entrance side of the first image display member 11. It may also include a polarizing plate 15 at the light exit side of the second image display member 32.

In the present embodiment, a liquid crystal panel is used as the first image display member 11. As illustrated in FIG. 4B, the first image display member 11 includes a translucent panel substrate 11a, on which a pixel layer 21 is formed. The pixel layer 21 had a predetermined pixel arrangement.

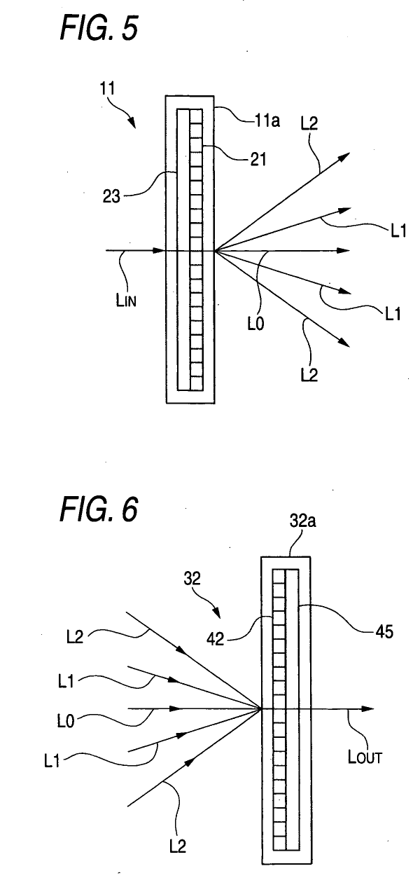

FIG. 5 illustrates a structure of the first image display member. As illustrated in FIG. 5, the first image display member 11 is provided, on the panel substrate 11a, with a pixel layer 21 and a liquid crystal layer 23. In the illustrated example, the liquid crystal layer 23 is formed at the light entrance side of the pixel layer 21. Such structure allows to prevent a situation where the lights are not appropriately recombined in the second image display member 32 due to a change in the phase of the light when the incident light Lᵢₙ is passed through the liquid crystal layer 23 after it is diffracted.

The focusing member 13a and 13b have a function of condensing, onto the optical element 32, diffracted lights (1st-order light L1 and 2nd-order light L2 in FIG. 4) of the incident light Lᵢₙ, diffracted from the light which proceeds straight (0th-order light L0 in FIG. 4) from the first image display member 11. A lens or a mirror may be utilized as the focusing member 13a and 13b.

FIG. 6 illustrates the structure of the second image display member. As illustrated in FIGS. 4C and 6, the second image display member 32 has a function of recombining the diffracted lights (L1 and L2) condensed by the imaging member 13b. The light Lₒᵤₜ recombined by the second image display member 32 is guided, in case of a liquid crystal projector, to a projection lens and projected onto a screen.

The second image display member 32 may be constituted of a liquid crystal panel, having a same structure as in the first image display member 11. The second image display member 32 is characterized in having a pixel arrangement, that is point symmetrical to the pixel arrangement of the first image display member 11. More specifically, as illustrated in FIGS. 4B and 4C, coordinates of each pixel in the pixel arrangement, when the second image display member 32 is seen as a plan view from the side of the focusing member 13a and 13b, correspond to those in pixel arrangement of the first image display member 11, seen as a plan view from the side of the focusing member 13a and 13b, in a state rotated by 180° about a center of the pixel arrangement. Stated differently, a direction of x1 axis of the first image display member 11 illustrated in FIG. 4B corresponds to a direction of x2 axis of the second image display member 32 illustrated in FIG. 4C, and a direction of y1 axis of the first image display member 11 illustrated in FIG. 41B corresponds to a direction of y2 axis of the second image display member 32 illustrated in FIG. 4C.

In the present embodiment, a distance F between the first image display member 11 and the focusing member 13a and a distance f between the focusing member 13b and the second image display member 32 are in such an optically conjugate relationship that the diffracted lights from the first image display member 11 can be recombined by the second image display member 32.

The liquid crystal display apparatus 20 of the invention is so constructed that the light is diffracted by the first image display member 11 and is then recombined by the focusing member 13a and 13b onto the second image display member 32, and that the second image display member 32 is optically conjugate with the pixel arrangement of the first image display member 11 and has a pixel arrangement which is point symmetrical with that of the first image display member 11. The diffraction can be prevented by once diffracting the incident light by the first image display member 11 and recombining the diffracted lights by the focusing member 13a and 13b onto the second image display member 32. Therefore, the proceeding direction and the polarizing direction are not changed between the incident light Lᵢₙ and the emergent light Lₒᵤₜ, whereby a luminance increase by a light leak can be prevent. Therefore a loss in the contrast ratio of the displayed image can be prevented.

It is also possible, by constituting each of the first image display member 11 and the second image display member 32 by a liquid crystal panel, to halve the burden per a liquid crystal panel, thereby increasing the operation speed. In a simple calculation, an operation of a doubled operation speed is possible. Since a phase difference given to the incident light can be halved per a liquid crystal panel, an alignment control amount for the liquid crystal molecules is accordingly reduced to about a half, whereby a high-speed operation is made possible.

In the following, an example of the liquid crystal display apparatus of the present embodiment will be explained.

The liquid crystal display apparatus of the present example employed, as each of the first image display member and the second image display member, a liquid crystal panel having a pixel pitch d of 25 μm, having, at a wavelength of λ=550 μm, a ±1st-order diffraction angle of ±1.26° and a diffraction angle to ±3rd order of ±3.78°. The focusing member was constituted, in consideration of a spreading (about ±10°) in the light incident angle to the liquid crystal panel, of a lens having a focal length of f=50 mm, capable of covering an angle within ±14° (preferably having a diameter of 50 mm of larger, and may be a Fresnel lens) The liquid crystal panel and the lens had a distance of 100 mm, and the lens and the second image display member had a distance of 100 mm. The lights diffracted by the liquid crystal panel were condensed by the lens onto the second image display member constituting an optical element, and were thus recombined by a process inverse to the diffraction. A loss in the contrast ratio could be prevented by the present example.

The diffraction angle θ can be represented by θ=sin⁻¹(mλ/d), in which d sinθ=mλ, wherein m is a diffraction orde, d is a pitch of pixels and λ is a wavelength.

Now there will be explained a process of transition from a black display state to a white display state, as an example of moving image display in the present example.

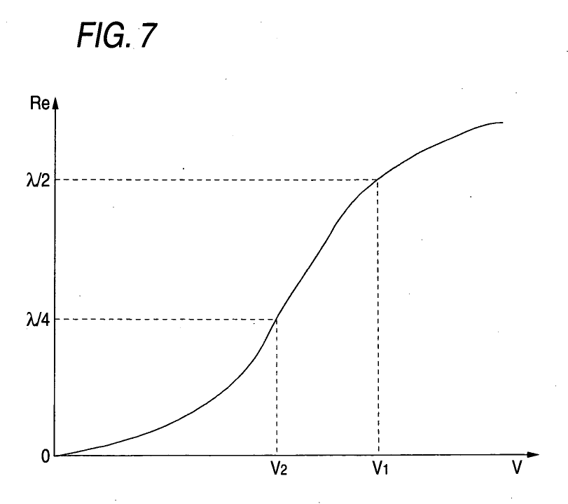

FIG. 7 is a chart that illustrates a relationship, in a moving image display, between a voltage (V) applied for controlling the alignment of the liquid crystal molecules, and a phase difference (retardation Re) given to the light. As illustrated in FIG. 7, the liquid crystal layer gives a phase difference 0 to the light in a black display state, but, in a white display state, a predetermined voltage V₁ is applied to provide a phase difference λ/2. As the system of the invention only requires a phase difference of λ/4 per each liquid crystal layer by controlling the voltage at a predetermined value V₂, the load is halved in a simple calculation and the amount of alignment of the liquid crystal molecules is accordingly halved, whereby a faster operation is rendered possible.

The present invention is not limited to the embodiment described above but is subject to suitable modifications and improvements.

The optical element may be formed by a member same as the image display member, for example a liquid crystal panel of a same pixel arrangement. However, the optical element may be formed by a pixel-structured filter, thereby reducing the cost of the constituent parts.

Furthermore, in the first embodiment, an alignment of the image display member and the optical element may be changed one another.

The present application claims foreign priority based on Japanese Patent Application (JP 2005-247910) filed Aug. 29 of 2005, and Japanese Patent Application (JP 2005-247913) filed Aug. 29 of 2005, the contents of which is incorporated herein by reference.

What is claimed is:

1. A liquid crystal display apparatus comprising:
an image display member diffracting an incident light;
a focusing member condensing diffracted lights diffracted by the image display member; and
a optical element recombining lights condensed by the focusing member,
wherein.
the image display member comprises a liquid display panel having a pixel arrangement, and
the optical element has a pixel arrangement being a point symmetrical to the pixel arrangement of the image display member.

2. The liquid crystal display apparatus according to claim 1,
wherein the focusing member is one of a lens and a mirror.

3. The liquid crystal display apparatus according to claim 1,
wherein the optical element comprises a pixel-structured filter including a translucent substrate and a pixel layer corresponding to the image display member.

4. The liquid crystal display apparatus according to claim 1, which comprises:
polarizing elements are provided at a light entrance side and a light exit side of the image display member, respectively.

5. The liquid crystal display apparatus according to claim 1′,
wherein
the image display member comprises:
a translucent panel substrate;
a liquid crystal layer formed on the panel substrate; and
a pixel layer.

6. The liquid crystal display apparatus according to claim 1,
wherein
the focusing member comprises a pair of lenses, and
the diffracted lights are changed to parallel lights by one lens and the parallel lights are condensed to the optical element by the other.

7. A liquid crystal display apparatus comprising:
a first image display member diffracting an incident light;
a focusing member for condensing diffracted lights diffracted by the first image display member; and
a optical element for recombining lights condensed by the focusing member,
wherein
each of the first image display member and the optical element are liquid display panels having a pixel arrangement, and
the optical element has a pixel arrangement which is point symmetrical to the pixel arrangement of the first image display member.

8. The liquid crystal display apparatus according to claim 7, wherein the focusing member is one of a lens and a mirror.

9. The liquid crystal display apparatus according to claim 7, which comprises,
polarizing elements are provided at a light entrance side of the first image display member and at a light exit side of the optical element, respectively.

10. The liquid crystal display apparatus according to claim 7,
wherein
the image display member comprises:
a translucent panel substrate;
a liquid crystal layer formed on the panel substrate; and
a pixel layer.

11. A liquid crystal display apparatus according to claim 7,
wherein
the optical element comprises:
a translucent panel substrate;
a liquid crystal layer formed on the panel substrate; and
a pixel layer.

12. The liquid crystal display apparatus according to claim 7,
wherein
the focusing member comprises a pair of lenses, and
the diffracted lights are changed to parallel lights by one lens and the parallel lights are condensed to the optical element by the other.
